(19) United States
(12) Patent Application Publication
(10) Pub. No.: US 2009/0280228 A1
(43) Pub. Date: Nov. 12, 2009

(54) BEVERAGE STIRRING DEVICE

(76) Inventors: A. Marc Gillinov, Orange Village, OH (US); Kenneth N. Litwak, Orange Village, OH (US); Curtis Taylor, Chagrin Falls, OH (US)

Correspondence Address: Mark J. Pandiscio;Pandiscio & Pandiscio, P.C., 470 Totten Pond Road, Waltham, MA, 02451-1914, US

(21) Appl. No.: 12/397,194

(22) Filed: Mar. 3, 2009

Related U.S. Application Data
(60) Provisional application No. 61/067,916, filed on Mar. 3, 2008.

(51) Int. Cl. B01F 9/22; A23L 2/52

(52) U.S. Cl. 426/519; 366/204

(57) ABSTRACT

A beverage stirring device comprising:
a frame for supporting the beverage stirring device relative to a work surface, the frame comprising a longitudinal axis extending substantially perpendicular to the work surface;
a motor comprising a housing and a drive shaft rotatable relative to the housing, the drive shaft being substantially aligned with the longitudinal axis of the frame;
a weight eccentrically mounted to the drive shaft;
at least one spring for movably mounting the housing of the motor to the frame; and
a container-receiving surface connected to the housing of the motor for receiving a beverage container, the container-receiving surface extending substantially parallel to the work surface and perpendicular to the longitudinal axis of the frame,
whereby operation of the motor imparts a gyrating motion to a beverage container seated on the container-receiving surface, so as to stir a beverage contained in the beverage container.

### REFERENCE TO PENDING PRIOR PATENT APPLICATION

This patent application claims benefit of pending prior U.S. Provisional Patent Application Ser. No. 61/067,916, filed Mar. 3, 2008 by A. Marc Gillinov et al. for COFFEE STIRRING DEVICE (Attorney's Docket No. 31827-Pending), which patent application is hereby incorporated herein by reference.

### FIELD OF THE INVENTION

This invention relates to stirring devices in general, and more particularly to devices for stirring additives into a beverage, such as stirring milk and/or sugar into coffee.

### BACKGROUND OF THE INVENTION

There are many food-serving establishments (e.g., restaurants, coffee shops, donut shops, fast food restaurants, gas stations, convenience stores, etc.) that offer a wide variety of beverages to their customers. Many of these beverages, particularly coffee and tea, are often enjoyed with the addition of various beverage additives.

More particularly, it is quite common for customers to add various beverage additives to their beverage after receiving the beverage and before consuming it. By way of example but not limitation, in the case of coffee, it is common for a customer to add cream, milk, a non-dairy creamer, sugar or a sugar substitute, and/or other desired items to their coffee before consuming the coffee. Traditionally, the customers have manually mixed such beverage additives into their beverage themselves, e.g., by using a spoon, disposable stirrer and/or other appropriate mixing utensil that is placed inside the beverage container and then stirred in a generally circular motion so as to thoroughly mix and disperse the beverage additives throughout the beverage.

Many take-out establishments provide their customers with disposable spoons or, more commonly, disposable stirrers (e.g., plastic or wooden stir sticks), in order to eliminate the need to wash every spoon or other stirring utensil after each use. Typically, these disposable stirrers are stored in a box or similar container with a large number of other stirrers. With these stirrers all contained in the same box, the customer must reach into the box and remove their stirrer, which can easily lead to contamination of the remaining stirrers. More particularly, if a customer has dirty hands or a cold or other illness, they may touch (and thus potentially contaminate) adjacent stirrers as they remove their own stirrer from the box of stirrers.

In addition, the use of a large number of disposable stirrers can be uneconomical as well as environmentally undesirable.

Furthermore, the use of disposable stirrers and/or other mixing utensils frequently results in a “messy” mixing area, e.g., as the disposable stirrers are transferred to the trash after stirring, etc. In a busy establishment, the mixing area must be continuously cleaned up in order to avoid a dirty and unclean appearance. Thus, the use of disposable stirrers and/or other mixing utensils generally contributes to the “mess factor” which must be addressed by the establishment.

Therefore, a substantial need exists for a new and improved beverage stirring device that can thoroughly and automatically mix the desired beverage additives into the beverage while the beverage is contained in a standard drinking container (such as a coffee cup, travel mug, and the like) without requiring any manual mixing or the placement of mixing utensils into the beverage.

### SUMMARY OF THE INVENTION

The aforementioned need is met by the provision and use of a novel beverage stirring device which is designed to automatically mix the desired beverage additives into the beverage while the beverage is contained in a standard drinking container and without requiring any manual mixing or the placement of mixing utensils into the beverage. As a result, the aforementioned issues of contamination, cost, environmental concerns and “mess factor” associated with disposable utensils and disposable stirrers are eliminated.

In one preferred form of the invention, there is provided a novel beverage stirring device comprising:

a frame for supporting the beverage stirring device relative to a work surface, the frame comprising a longitudinal axis extending substantially perpendicular to the work surface;

a motor comprising a housing and a drive shaft rotatable relative to the housing, the drive shaft being substantially aligned with the longitudinal axis of the frame;

a weight eccentrically mounted to the drive shaft;

at least one spring for movably mounting the housing of the motor to the frame; and

a container-receiving surface connected to the housing of the motor for receiving a beverage container, the container-receiving surface extending substantially parallel to the work surface and perpendicular to the longitudinal axis of the frame,

whereby operation of the motor imparts a gyrating motion to a beverage container seated on the container-receiving surface, so as to stir a beverage contained in the beverage container.

In another form of the invention, there is provided a method for stirring additives into a beverage, the method comprising:

providing a beverage stirring device comprising:
a frame for supporting the beverage stirring device relative to a work surface, the frame comprising a longitudinal axis extending substantially perpendicular to the work surface;
a motor comprising a housing and a drive shaft rotatable relative to the housing, the drive shaft being substantially aligned with the longitudinal axis of the frame;
a weight eccentrically mounted to the drive shaft;
at least one spring for moveably mounting the housing of the motor to the frame; and
a container-receiving surface connected to the housing of the motor for receiving a beverage container, the container-receiving surface extending substantially parallel to the work surface and perpendicular to the longitudinal axis of the frame;

placing the beverage container on the container-receiving surface; and

energizing the motor so as to cause the weight to rotate about the longitudinal axis of the drive shaft, thereby imparting a gyrating motion to the beverage container seated on the container-receiving surface, so as to stir a beverage contained in the beverage container.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic view showing a beverage stirring device formed in accordance with the present invention, wherein the beverage stirring device is mounted in a counter;

FIG. 2 is a side view of the beverage stirring device shown in FIG. 1;

FIG. 3 is a top view of the beverage stirring device shown in FIG. 1;

FIG. 3A is a schematic view of a typical beverage container which may be used in conjunction with the beverage stirring device of the present invention;

FIGS. 4 and 5 are schematic views, in section, of the beverage stirring device shown in FIG. 1;

FIGS. 6 and 7 are schematic views of the beverage stirring device shown in FIG. 1, with the plastic casing of the beverage stirring device having been removed;

FIGS. 8-10 are schematic views showing how the beverage stirring device of FIG. 1 may be mounted in a counter;

FIG. 11 is a schematic view showing a beverage container (e.g., a cup) being placed on the beverage stirring device of FIG. 1; and

FIGS. 12 and 13 are schematic views showing a switch for automatically activating on the beverage stirring device when a beverage container is positioned on the beverage stirring device.

### DETAILED DESCRIPTION OF THE PREFERRED EMBODIMENTS

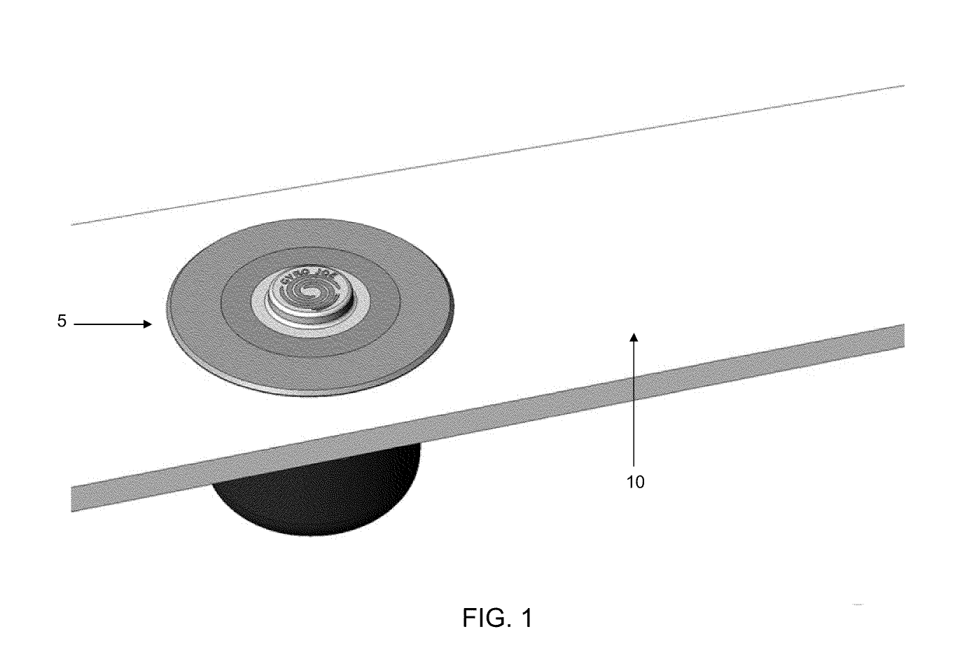

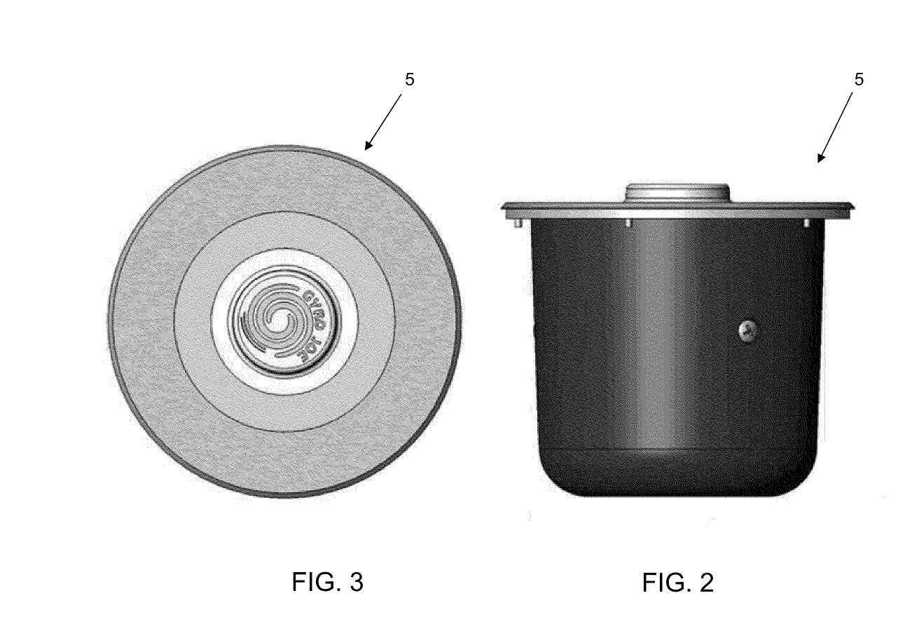

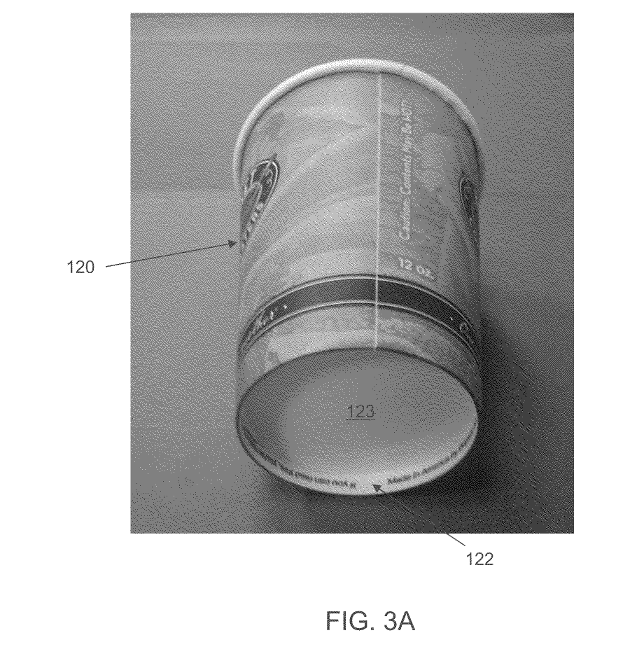

Looking first at FIGS. 1-5, there is shown a beverage stirring device 5 formed in accordance with the present invention. Beverage stirring device 5 preferably comprises a substantially closed, self-contained unit which is intended to be mounted into a counter 10 so that the top of the beverage stirring device is substantially flush with the top surface of counter 10. Beverage stirring device 5 is intended to receive a standard beverage container (e.g., a coffee cup, a travel mug, etc.) and automatically mix the contents thereof (e.g., the beverage and beverage additives) without requiring any manual mixing or the placement of mixing utensils into the beverage, as will hereinafter be discussed in further detail. In one preferred form of the invention, and looking now at FIG. 3A, beverage stirring device 5 is intended to be used with a standard beverage container (e.g., cup) 120 of the type which comprises a bottom rim 122 which protrudes beyond the floor 123 of the beverage container.

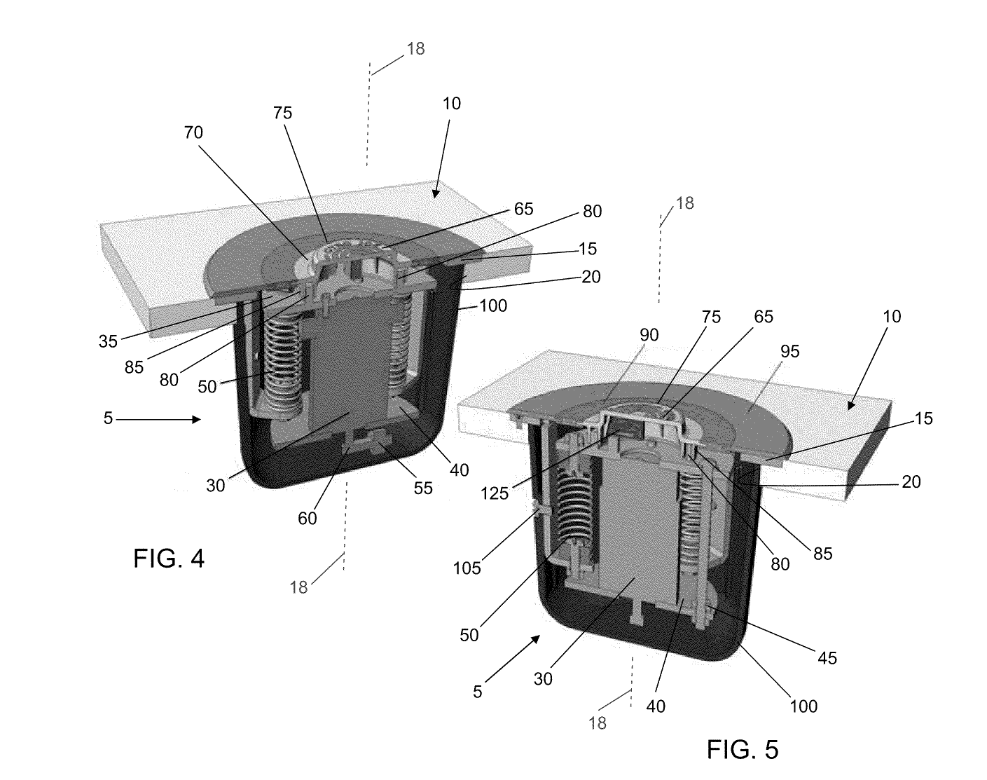

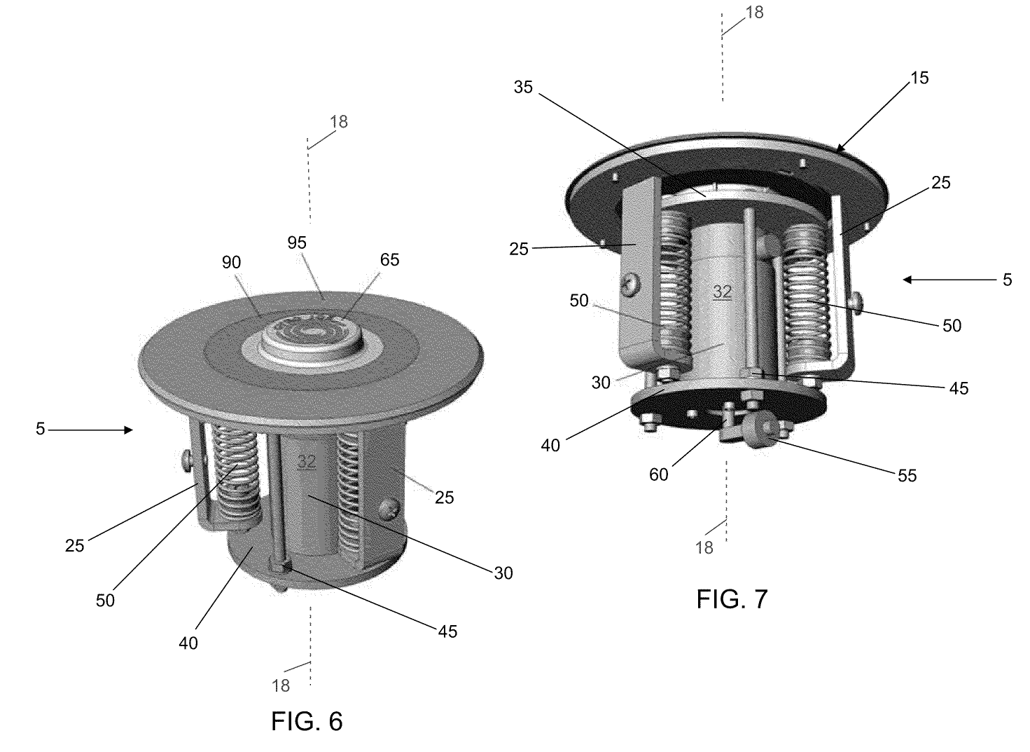

Looking next at FIGS. 4-7, beverage stirring device 5 preferably comprises an annular ring 15 which is intended to be mounted to counter 10, about an opening 20 formed in counter 10, as will hereinafter be discussed in further detail. Annular ring 15 comprises a longitudinal axis 18. Annular ring 15 serves to secure the remainder of beverage stirring device 5 to counter 10. A plurality of vibration brackets 25 are secured to annular ring 15 and descend downwardly therefrom. Preferably three vibration brackets 25 are provided, spaced equidistantly about the circumference of annular ring 15 (i.e., the three vibration brackets 25 are spaced 120 degrees apart).

Beverage stirring device 5 also comprises a motor 30 comprising a housing 32 and a drive shaft 60. Motor 30 is captured between an upper end plate 35 and a lower end plate 40 by a plurality of bolts 45. Springs 50 movably connect upper end plate 35 to vibration brackets 25, with motor 30 being disposed so that its drive shaft 60 is substantially co-axial with annular ring 15 (i.e., so that its drive shaft 60 is substantially aligned with the longitudinal axis 18 of annular ring 15). Motor 30 has a weight 55 eccentrically mounted to its drive shaft 60.

As a result of this construction, when motor 30 is energized, eccentric weight 55 is spun rapidly about the axis of drive shaft 60, causing motor 30, upper end plate 35 and lower end plate 40 to gyrate at high speed, on springs 50, about longitudinal axis 18. By appropriately choosing the various system components (e.g., speed of the motor, mass of eccentric weight 55, the spring constant of springs 50, etc.), motor 30, upper end plate 35 and lower end plate 40 can be made to gyrate at high speed, in a high frequency vibratory fashion, about longitudinal axis 18 of annular ring 15.

An activation element 65 is attached to upper end plate 35 so that the gyrating motion of upper end plate 35 is transferred to activation element 65. Activation element 65 preferably comprises an annular base 70 having an island 75 rising therefrom, whereby to receive the bottom of beverage container 120, as will hereinafter be discussed in further detail. Activation element 65 is preferably attached to upper end plate 35 via male and female annular rings, e.g., a male ring 80 extending upwardly from upper end plate 35 and a female annular ring 85 extending downwardly from annular base 70 of activation element 65. Male ring 80 and female ring 85 preferably make a friction fit with one another so as to transfer motion from upper end plate 35 to activation element 65. An elastomer 90 connects annular base 70 of activation element 65 to a ring frame 95.

Preferably, activation element 65, elastomer 90 and ring frame 95 together completely close off opening 20 formed in counter 10, with activation element 65, elastomer 90 and ring frame 95 preferably joining one another in watertight seals. Thus, any liquids and/or granules and powders spilled on activation element 65, elastomer 90, ring frame 95 and/or counter 10 can be quickly and easily cleaned up.

A plastic casing 100 is preferably secured to vibration brackets 25 via screws 105. The top end of plastic casing 100 preferably mates with the underside of ring frame 95 so as to completely enclose the working elements of beverage stirring device 5. Plastic casing 100 has an opening (not shown) for permitting an electric power line to be connected to motor 30, whereby to selectively energize the motor.

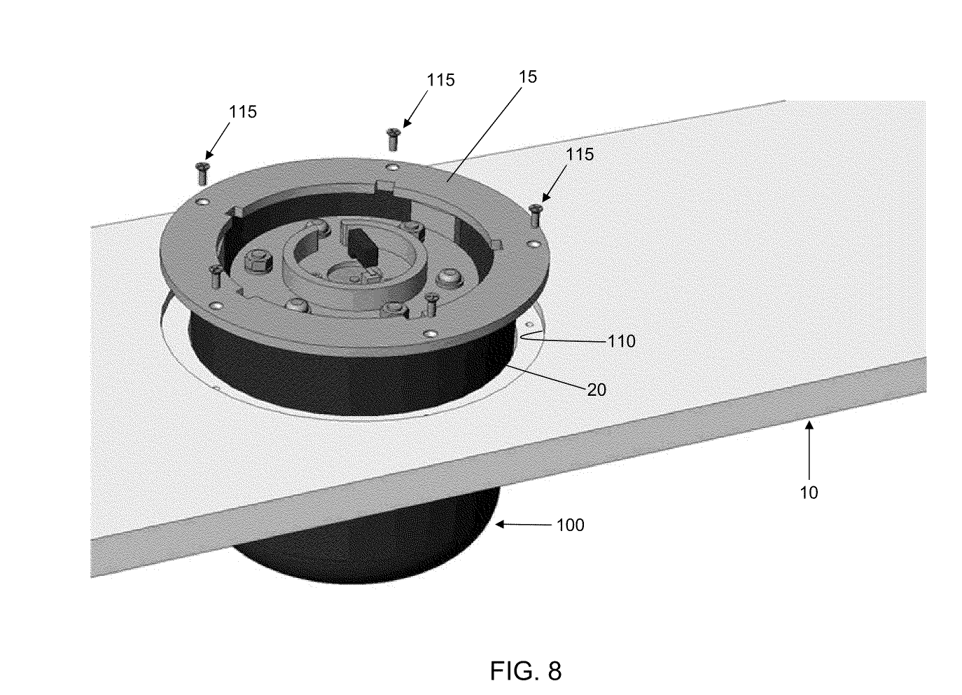

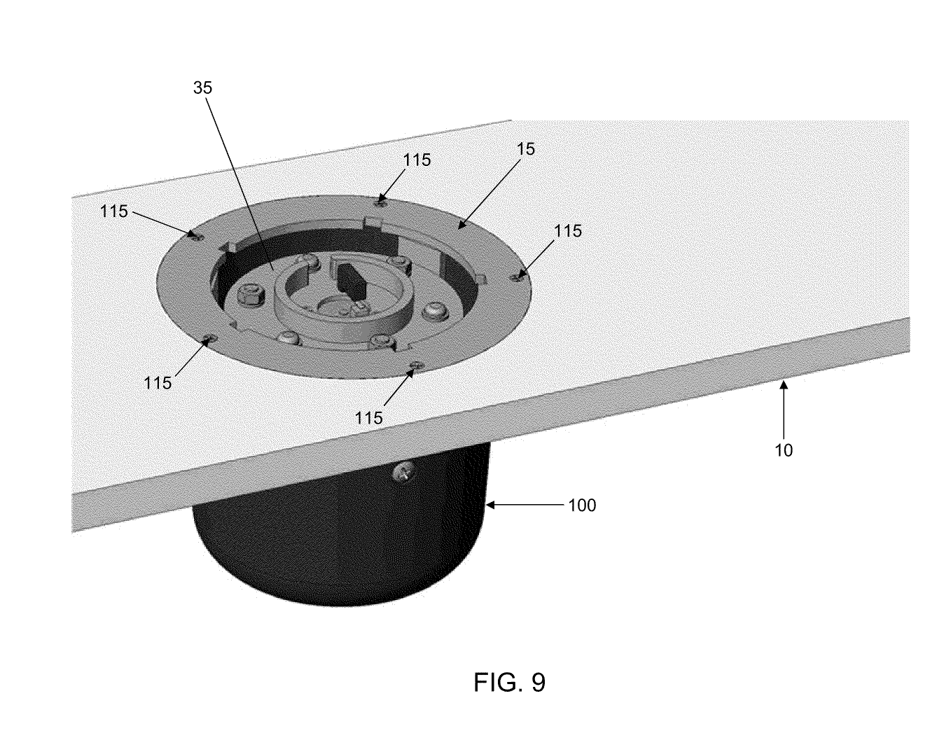

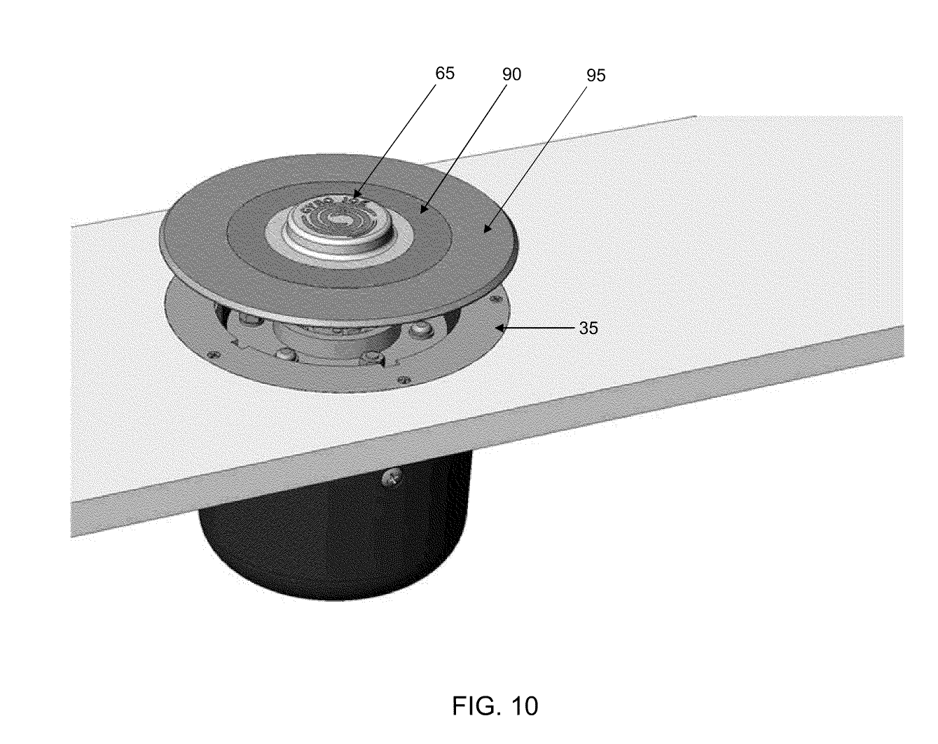

Looking next at FIGS. 8-10, beverage stirring device 5 is intended to be mounted to counter 10 by passing plastic casing 100 through opening 20 in counter 10 until annular ring 15 seats in a counterbore 110 formed about the perimeter of opening 20. Then annular ring 15 is secured to counter 10 with screws 115. Then activation element 65, elastomer 90 and ring frame 95 are set over upper end plate 35 (see FIGS. 1 and 10).

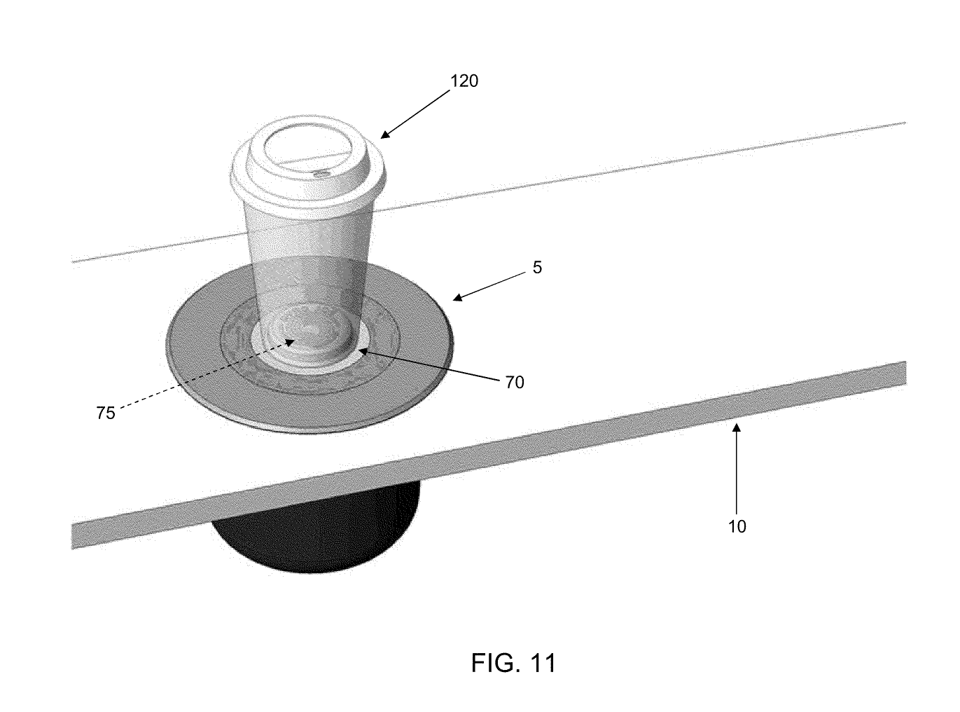

In use, and looking now at FIG. 11, cup 120, containing both a beverage and the beverage additive which is to be mixed therein, is placed on activation element 65 so that the protruding rim 122 of the cup co-axially overlies island 75 and seats on annular base 70. The upraised floor 123 of the cup may or may not contact the top of island 75. At this point motor 30 is activated, causing eccentric weight 55 to slowly spin about the axis of drive shaft 60. This action in turn causes motor 30, upper end plate 35 and lower end plate 40 to gyrate at high speed, on springs 50, about longitudinal axis 18 of annular ring 15, in a high frequency vibratory fashion. This high speed gyrating, high frequency vibratory motion is transferred to activation element 65, and in turn to cup 120 and its contents, whereby to agitate the contents of the cup and thereby mix the beverage additives into the beverage. Significantly, this agitation is effected using the aforementioned high speed gyrating, high frequency vibratory motion, so that the contents of the cup remain safely within the cup, without any spillage, while mixing the contents of the cup thoroughly from top to bottom. And significantly, this mixing action takes place without any manual mixing or requiring the placement of mixing utensils into the beverage.

Thus it will be seen that use of beverage stirring device 5 eliminates the aforementioned issues of contamination, cost, environmental concerns and “mess factor”.

In one form of the invention, motor 30 may be activated with a conventional hand-operated or foot-operated switch interposed in the electric power line between beverage stirring device 5 and a wall plug.

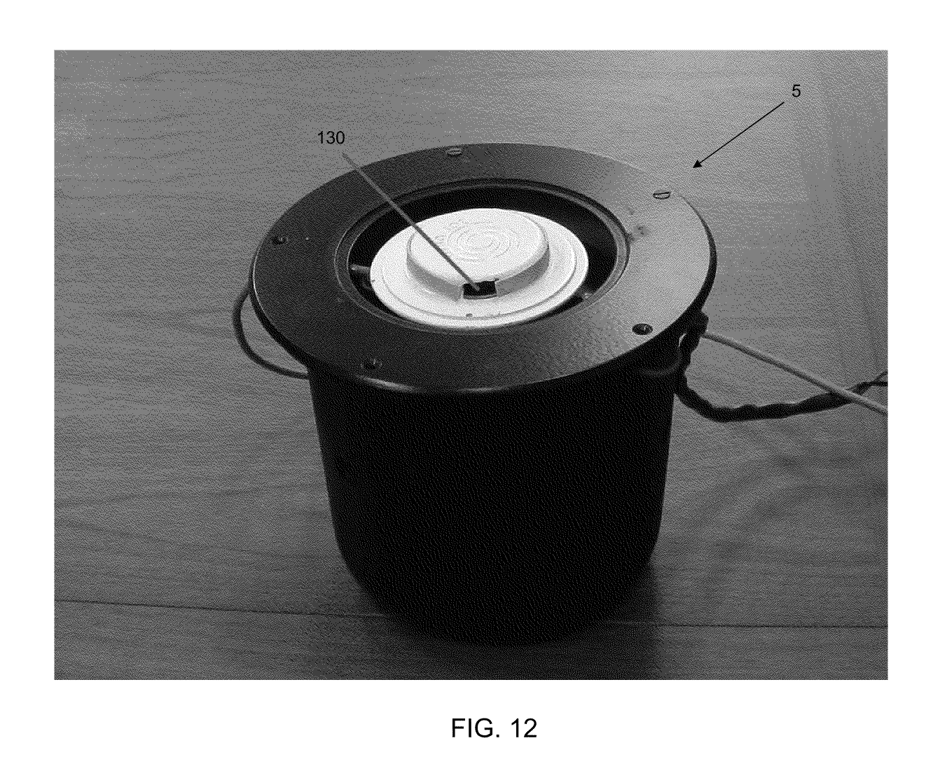

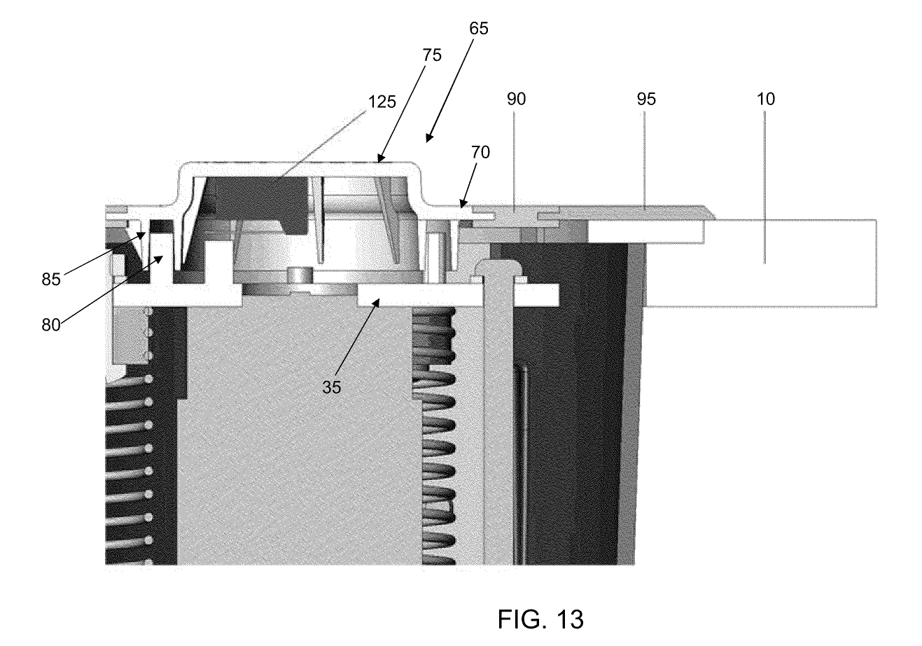

However, in another form of the invention, and looking now at FIGS. 12 and 13, an infrared (IR) switch 125 and a window 130 (for emitting the beam of IR switch 125 and receiving back the reflected beam of IR switch 125) are provided in order to activate motor 30 automatically upon seating of cup 120 on activation element 65. Thus, with this form of the invention, the customer simply places cup 120 on activation element 65, and IR switch 125 automatically starts motor 30. When cup 120 is removed, IR switch 125 automatically stops motor 30.

Alternatively, IR switch 125 can be replaced with an ultrasound-based switch 125, whereby to detect the presence of a cup 120 on activation element 65.

In the foregoing description, activation element 65 is depicted as a raised island 75 surrounded by an annular base 70. This construction can be preferred, since it provides an excellent seat for a cup 120 of the type shown in FIG. 3A, i.e., a cup having a protruding bottom rim 122 with a raised floor 123, which mates with annular base 70 (and, in some cases, raised island 75). However, in some circumstances, it may be desirable to use beverage stirring device 5 with a cup having a flat bottom, or with cups having various other geometries which might not mate perfectly with annular base 70 and/or raised island 75. In this case, activation element 65 may comprise a recess, allowing the beverage container to be seated into the recess.

Furthermore, in the foregoing description, beverage stirring device 5 is shown mounted within counterbore 120 of counter 10. However, it should also be appreciated that beverage stirring device 5 could sit on top of a counter or table. By way of example but not limitation, a housing could be used to support annular ring 15 (and the remainder of the device) above the surface of a counter or table, with the housing having feet for disposition on the surface of the counter or table.

Thus it will be seen that the present invention provides an improved beverage stirring device that can thoroughly and automatically mix the desired beverage additives into the beverage while the beverage is contained in a standard drinking container (such as a coffee cup, travel mug, and the like) without requiring any manual mixing or the placement of mixing utensils into the beverage.

### MODIFICATIONS

It will be appreciated that still further embodiments of the present invention will be apparent to those skilled in the art in view of the present disclosure. It is to be understood that the present invention is by no means limited to the particular constructions and method steps herein disclosed and/or shown in the drawings, but also comprises any modifications or equivalents within the scope of the invention.

What is claimed is:

1. A beverage stirring device comprising:
a frame for supporting the beverage stirring device relative to a work surface, the frame comprising a longitudinal axis extending substantially perpendicular to the work surface;
a motor comprising a housing and a drive shaft rotatable relative to the housing, the drive shaft being substantially aligned with the longitudinal axis of the frame;
a weight eccentrically mounted to the drive shaft;
at least one spring for movably mounting the housing of the motor to the frame; and
a container-receiving surface connected to the housing of the motor for receiving a beverage container, the container-receiving surface extending substantially parallel to the work surface and perpendicular to the longitudinal axis of the frame,
whereby operation of the motor imparts a gyrating motion to a beverage container seated on the container-receiving surface, so as to stir a beverage contained in the beverage container.

2. A beverage stirring device according to claim 1 wherein the frame is annular, and further wherein a portion of the frame is received in an opening in the work surface.

3. A beverage stirring device according to claim 2 wherein the longitudinal axis of the motor is co-axial with the center of the opening in the work surface.

4. A beverage stirring device according to claim 1 wherein at least a portion of the frame sits below the work surface.

5. A beverage stirring device according to claim 1 wherein at least a portion of the frame sits on top of the work surface.

6. A beverage stirring device according to claim 1 wherein the container-receiving surface comprises an annular base and an island rising therefrom so that the beverage stirring device can receive the rim of a beverage cup.

7. A beverage stirring device according to claim 1 wherein the beverage stirring device further comprises an elastomeric element disposed between the container-receiving surface and at least one of the frame and the work surface.

8. A beverage stirring device according to claim 1 further comprising a switch for activating the motor.

9. A beverage stirring device according to claim 8 wherein the switch is hand-operated.

10. A beverage stirring device according to claim 8 wherein the switch is foot-operated.

11. A beverage stirring device according to claim 1 wherein the motor is automatically activated when a container is placed on the container-receiving surface.

12. A beverage stirring device according to claim 11 wherein the motor is automatically activated by an infrared (IR) switch.

13. A beverage stirring device according to claim 11 wherein the motor is automatically activated by an ultrasound switch.

14. A method for stirring additives into a beverage, the method comprising:
providing a beverage stirring device comprising:
a frame for supporting the beverage stirring device relative to a work surface, the frame comprising a longitudinal axis extending substantially perpendicular to the work surface;
a motor comprising a housing and a drive shaft rotatable relative to the housing, the drive shaft being substantially aligned with the longitudinal axis of the frame;
a weight eccentrically mounted to the drive shaft;
at least one spring for moveably mounting the housing of the motor to the frame; and
a container-receiving surface connected to the housing of the motor for receiving a beverage container, the container-receiving surface extending substantially parallel to the work surface and perpendicular to the longitudinal axis of the frame;
placing the beverage container on the container-receiving surface; and
energizing the motor so as to cause the weight to rotate about the longitudinal axis of the drive shaft, thereby imparting a gyrating motion to the beverage container seated on the container-receiving surface, so as to stir a beverage contained in the beverage container.
